(19) United States
(12) Patent Application Publication
(10) Pub. No.: US 2016/0029031 A1
(43) Pub. Date: Jan. 28, 2016

(54) METHOD FOR COMPRESSING A VIDEO AND A SYSTEM THEREOF

(71) Applicant: National Taiwan University of Science and Technology, Taipei City (TW)

(72) Inventors: Chin-Shyurng Fahn, Taipei City (TW); Meng-Luen Wu, Taipei City (TW); Chun-Chang Liu, Taipei City (TW)

(21) Appl. No.: 14/445,499

(22) Filed: Jul. 29, 2014

(30) Foreign Application Priority Data
Jul. 24, 2014 (TW) 103102634

(51) Int. Cl. H04N 19/23; H04N 19/51; H04N 19/543

(52) U.S. Cl. CPC H04N 19/23; H04N 19/543; H04N 19/51

(57) ABSTRACT

The present invention discloses a system for compressing a video, and comprises a capture module, a first analysis module, a clustering module and a compressing module. The system of the present invention can capture a background portion from the video and reserve characteristics such as the moving route or speed of the target object. Based on the non-collision among the objects, the objects existing at different times can be re-synthesized into the same time slice to generate a compressed video with the shortest duration while still retaining the full content of the original video according to the system of the present invention.

### PRIORITY CLAIM

This application claims the benefit of the filing date of Taiwan Patent Application No. 103102634, filed Jan. 24, 2014, entitled “A METHOD FOR COMPRESSING A VIDEO AND A SYSTEM THEREOF,” and the contents of which are hereby incorporated by reference in their entirety.

### FIELD OF THE INVENTION

The present invention relates to a method for video processing and a system thereof, more particularly, to a method for compressing a video and a system thereof for improving the harmony of the video screen, preventing objects in the video from shadowing each other, and increasing the compression rate of the video.

### BACKGROUND

The conventional video compression technology research mostly focuses on real-time online compression, compression rate, or the optimization of the time needed for video compression. However, there is no specific research on the effect of video compression having the viewing comfort of the human eye after the compression. The main purpose of video compression is that there is relatively less time for watching the video without missing any data of moving objects. However, the result after compressing the video creates objects with a variety of different speeds, directions, and positions appearing at the same time. Observers then have to frequently use the pause button to prevent the moving objects from being overlooked and thus losing the purpose of compressing the video.

Currently, in addition to personal computers and mobile devices, monitoring equipment and systems are the global industries with rapid development. However, most monitoring equipment is mainly focused on studying areas relating to the lens, the transmission, and storage equipment. There is not a lot of research on how to use artificial intelligence techniques on forensic and image processing of the video recorded by the monitoring equipment. Crime rate in cities was reduced by purchasing monitoring equipment and adding an artificial intelligence surveillance system, which dramatically increased the detection rate of crimes and deterred criminals from continuing to commit crimes. Major cities around the world are all committed to trying to reduce crime rate and increase the detection rate of crimes.

Due to the rapid spread of monitoring systems, new video monitors are installed every day. This decreases visual dead spots of monitoring ranges and further deters crimes from happening. But as long as the monitoring ranges keep increasing day by day, the database of the recorded videos will grow with them and cause considerable problems in saving the subsequent data and recorded content.

In terms of open spaces or screens with multiple entrances and exits, there are no limits to the moving path of the object, unlike a street or corridor, and there is no clear entry point or exit point. This causes the trajectories of the object to be unpredictable and difficult to cluster. With the precondition of not allowing collision, the moving paths of each object have mutual exclusion, which means that the overlapping moving paths of the objects cannot be arranged in the compressed video at the same time which results in the total time of the generated concentrated video associating with the order of permutations and the combinations of each objects appearing. Due to the whole surveillance video having over several hundred moving objects, there would be a need for a computational level of astronomical figures in order to calculate the optimal permutations and combinations.

Conventional technologies for compressing video are mostly focused on how to compress videos in the shortest time; however videos with the shortest time may not have the best visual effects. If the compressed result and entropy of the moving track properties is overly-low, then that means that the objects on the screen are too disorganized as some objects are moving faster, moving slower, and going towards multiple directions. Observers watching the compressed video will have to frequently use the pause button in order to prevent the moving objects from being overlooked. An observer using the pause button over and over again takes away the meaning of having a compressed video in the first place. Some methods of compressing video make the objects semitransparent in order to solve the problem of objects shadowing each other. These methods can effectively shorten the length of the video, but causes the interpretation of the objects to be difficult.

Therefore, given the absence of the applications conventional technologies, after careful testing and research, the final idea of a case, “a method for compressing a video and a system thereof” is created in order to overcome the shortcomings of the prior arts. The following is a brief description of the case.

### SUMMARY OF THE INVENTION

In order to solve the problem of the conventional technology, the present invention proposes a method for compressing a video and a system thereof.

The present invention provides a system for compressing a video comprising a capture module, a first analysis module, a clustering module, and a compression module. The capture module is used for capturing background data without any moving objects and at least one trajectory data with at least one target object from the video comprising a plurality of frames. The first analysis module is coupled to the capture module for analyzing a trajectory feature from the trajectory data. The clustering module is coupled to the first analysis module for clustering the target object to be a preset cluster from the trajectory feature. The compression module is coupled to the clustering module, the capture module, and the first analysis module for synthesizing the background data and the target object to be a compressed video according to the preset cluster, the trajectory data, and the trajectory feature.

The system for compressing the video of the present invention further comprises a first detection module, a second detection module, and a sequencing module. The first detection module is coupled to the clustering module for detecting an abnormal degree of the preset cluster. The second detection module is coupled to the capture module for detecting the frequency of the trajectory data passing through a target area in order to generate traffic volume data. The sequencing module is coupled to the first detection module, the second detection module, and the first analysis module for calculating an appearance time of the target object of the preset cluster in order to be sorted in the video according to the abnormal degree, the traffic volume data, and the trajectory feature, wherein the compression module is coupled to the sequencing module for synthesizing the background data and the target object to be a compressed video according to the appearance time.

Moreover, the system for compressing the video of the present invention further comprises the first processing module being coupled to the first detection module for generating a first weighting from large to small according to the abnormal degree of the preset cluster. The second processing module is coupled to the second detection module for generating a second weighting from smallest to largest according to the traffic volume data of the trajectory data.

In order to make the whole video achieve a higher compression rate, the sequencing module sorts the target object in the video according to the moving speed of the target object from fastest to slowest and the traffic volume data of the target object from smallest to largest.

In order to reduce the traffic jam in the video caused by the delay incurred by the collection while the target objects appearing in the screen and prevent the probability of collision between the target objects, the second detection module is further used for detecting the traffic volume data in order to generate a spatial occupation frequency of the target object in the target area with the second weighting of the low spatial occupation frequency larger than the second weighting of the high spatial occupation frequency.

In order to prevent the target objects on the screen from being overlooked, the compression module synthesizes the plurality of frames of the target object in the video to form the compressed video one by one.

Additionally, the system for compressing the video of the present invention further comprises a third analysis module, a third detection module, and a third processing module. The third analysis module is coupled to the compression module for analyzing the video and approximating the target object to be a quadrilateral shape in order to analyze the half of the sum of the length and width of the quadrilateral shape and a coordinate of a center point. The third detection module is coupled to the third analysis module for detecting whether a distance of the coordinate of the center point between two target objects is smaller than half of the sum of the length and the width of the two target objects. If it is, then determining that the two target objects are in a collision state, if it is not, then determining that the two target objects are in a non-collision state. The third processing module is coupled to the third detection module for continually synthesizing the frame belonging to the target object and the background data while the two target objects in the video are in the collision state in the next appearance time until the two target objects in the next frame are in the non-collision state, and then synthesizing the background data and the other remaining frames.

Finally, the present invention further provides a method for compressing a video comprising capturing a background data without any moving objects and at least one trajectory data with at least one target object from the video comprising a plurality of frames; analyzing a trajectory feature from the trajectory data; clustering the target object to be a preset cluster from the trajectory feature; detecting an abnormal degree of the preset cluster; detecting a frequency of the trajectory data passing through a target area to generate a traffic volume data; calculating an appearance time of the target object of the preset cluster to be sorted in the video according to the abnormal degree, the traffic volume data, and the trajectory feature; and synthesizing the background data and the target object to be a compressed video according to the preset cluster, the trajectory data, and the trajectory feature.

At the same time, the method for compressing the video of the present invention further comprises analyzing the video and approximating the target object to be a quadrilateral shape in order to analyze the half of the sum of the length and width of the quadrilateral shape and a coordinate of a center point; detecting whether a distance of the coordinate of the center point between the two target objects is smaller than the half of the sum of the length and width of the two target objects, if it is, then determining that the two target object are in a collision state, if not, then determining that the two target object are in a non-collision state; and continually synthesizing the frame belonging to the target object and the background data while the two target objects in the video are in the collision state in the next appearance time until the two target objects in the next frame are in the non-collision state, and then synthesizing the background data and the other remaining frames.

Compared to the prior art, the present invention provides a method for compressing a video and a system thereof, which can capture a background portion from a video and reserve characteristics such as the moving route or speed of a target object. Based on the non-collision among the objects, the objects existing at different times can be re-synthesized into the same time slice in order to generate a compressed video that consumes the least time while retaining full content of the video according to the system of the present invention in order to solve the disadvantages of the conventional technology.

Relating to advantages and spirits of the present invention can be further understood by the following description of the invention and the appended drawings.

### BRIEF DESCRIPTION OF THE DRAWINGS

FIG. 1 is a function block diagram illustrating the system for compressing the video of the present invention in a specific embodiment.

FIG. 2A is a schematic diagram illustrating the abnormal events detection of the invention in a non-clustering specific embodiment.

FIG. 2B is a schematic diagram illustrating the abnormal events detection of the invention in a clustering specific embodiment.

FIG. 3A is a schematic diagram illustrating the abnormal events detection of the invention in another non-clustering specific embodiment.

FIG. 3B is a schematic diagram illustrating the abnormal events detection of the invention in another clustering specific embodiment.

FIG. 4 is a schematic diagram illustrating the video compression of the invention in a specific embodiment.

FIG. 5A is a schematic diagram illustrating the collision detection of the invention in a collision specific embodiment.

FIG. 5B is a schematic diagram illustrating the collision detection of the invention in a non-collision specific embodiment.

FIG. 6 is a schematic diagram illustrating the collision detection of the invention in a specific embodiment.

FIG. 7 is a flow chart illustrating a method for compressing the video of the present invention in a specific embodiment.

### DETAILED DESCRIPTION

In order for the purpose, characteristics and advantages of the present invention to be more clearly and easily understood, the embodiments of the method for compressing the video and the system thereof combining appended drawings thereof are discussed in the following.

The present invention will classify the target objects with different classifications, so that the target objects with similar nature can appear in similar times, and the target object with different nature can appear in different times. Thus, the video after compression can be easy to watch to reach the purpose of a compressed video, wherein the target object of the present invention is a moving object, but is not limited thereto. In addition, regardless of the length of the video, viewers have the most attention in the beginning and their attention reduces as the video progresses. Therefore, the system for compressing the video of the present invention will first arrange the classification with the abnormal object to the front of the video in order to make things that need to be concerned to be watched first.

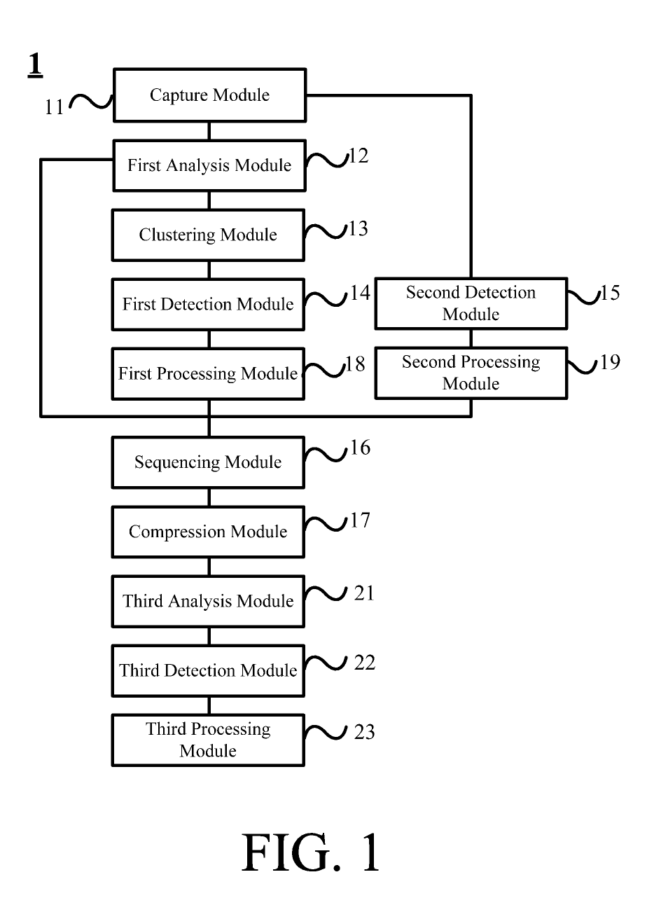

To better understand the technical character of the present invention, first refer to FIG. 1. FIG. 1 is a function block diagram illustrating the system for compressing the video of the present invention in a specific embodiment, as shown in the figure, a system for compressing a video 1 comprises a capture module 11, a first analysis module 12, a clustering module 13, a first detection module 14, a second detection module 15, a sequencing module 16, a compression module 17, a first processing module 18, a second processing module 19, a third analysis module 21, a third detection module 22, and a third processing module 23.

The capture module 11 captures background data without any moving objects and at least one of trajectory data with at least one target object from the video comprising a plurality of frames. The present invention can utilize probability and statistics or a variety of foreground—background segmentation algorithms, such as a Gaussian mixture model and other methods, for analyzing a video comprising a plurality of frames in order to generate a background without any moving objects, and then using background subtraction in order to detect the target object, wherein the target object is a moving object.

The first analysis module 12 is then coupled to the capture module 11 for analyzing a trajectory feature from the trajectory data. In the present embodiment, the invention can track the same target object by using methods such as Blob tracking, etc. in order to build the trajectory data of each target object. In more detail, the invention can analyze the trajectory feature from the trajectory data of each target object, such as moving direction, moving speed, persistent appearance time for the length of time, approaching position, distribution area, and whether it was located in a specific area, etc.

Then, the clustering module 13 is coupled to the first analysis module 12 for clustering the target object to be a preset cluster based on the trajectory feature. In other words, the target object will be clustered after acquiring all the trajectory features in order to divide the target object with the trajectory of similar properties to the same cluster. After clustering, each trajectory will be marked on the cluster to which it belongs. In the present embodiment, the marking of different clusters is based on different colors, but is not limited to this way.

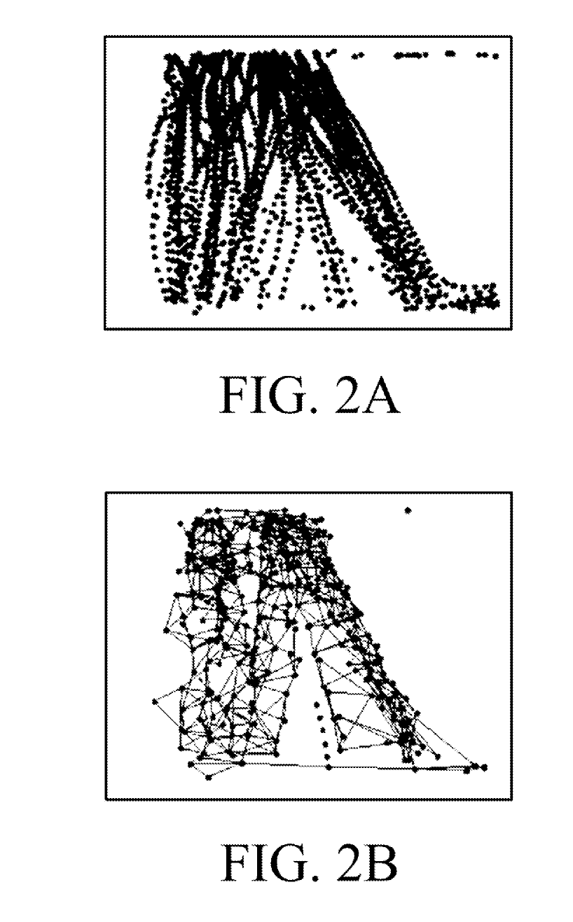

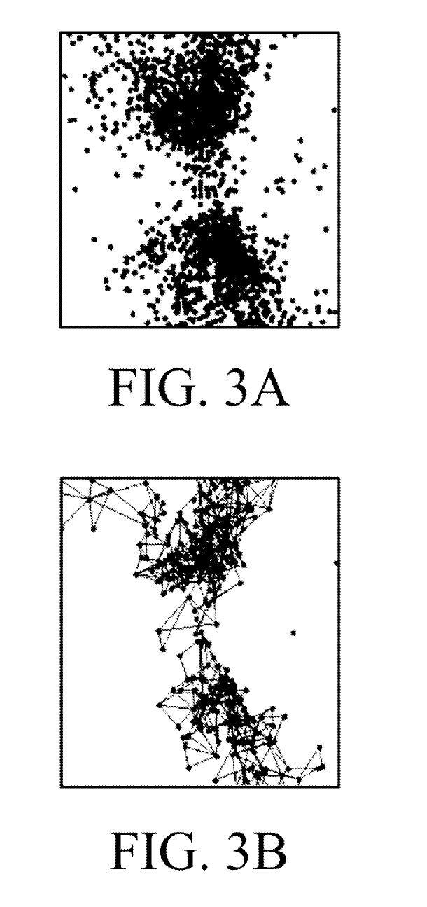

Moreover, in order to move the trajectory that deserves to be noted to the beginning time slice of the video, the present invention further performs an abnormal event detection for the entire trajectory passing through the above subject target. The abnormal event detection is used to detect the data points that differ from other trajectory data. The present invention utilizes the first detection module 14 coupled to the clustering module 13 for detecting an abnormal degree of the preset cluster. In the present embodiment, this involves selecting part of the trajectory feature in order to detect the abnormal target object. Firstly, while reselecting the part of the trajectory feature, the present invention mainly selects four trajectory features of the target object, its moving direction, moving speed, X-coordinate, and Y-coordinate as the input of the clustering algorithm. Thus, the present invention further classifies the trajectory data into a plurality of classifications with varying abnormal degree. In the present embodiment, the trajectory data is divided into very normal, biased normal, biased abnormality, very abnormal, and the plurality of classification with varying normal/abnormal degree. For example, the clustering algorithm of the self-organizing incremental neural network trains four dimensional trajectory features, which are the X-coordinate, Y-coordinate, moving direction, and moving speed in order to classify the moving target object into two clusters of either normal or abnormal. The result thereof is shown as FIG. 2A, FIG. 2B, FIG. 3A, and FIG. 3B. Please refer to FIG. 2A, FIG. 2B, FIG. 2A, and FIG. 3B. FIG. 2A is a schematic diagram illustrating the abnormal events detection of the invention in a non-clustering specific embodiment. FIG. 2B is a schematic diagram illustrating the abnormal events detection of the invention in a clustering specific embodiment. FIG. 3A is a schematic diagram illustrating the abnormal events detection of the invention in another non-clustering specific embodiment. FIG. 3B is a schematic diagram illustrating the abnormal events detection of the invention in another clustering specific embodiment. In the embodiment of FIG. 2A and FIG. 2B, the horizontal axis and the vertical axis are the X-coordinate and Y-coordinate separately. In the embodiment of FIG. 3A and FIG. 3B, the horizontal axis and the vertical axis are the speed and direction of the target object separately. Then, the trajectory data before clustering is clustered in order to get the trajectory data after clustering, categorizing the trajectory data connected together as the same cluster, and categorizing the trajectory data not connected as the abnormal target object. Thus, the present invention can conduct the abnormal event detection by using the method of clustering, but is not limited to this way. In practical application, users can also define an abnormal condition by themselves, such as a company requiring employees to wear uniforms to work, and if someone wears clothes that is not the color of the uniform it is then judged as abnormal; or if a specific turf is defined as an area that is not allowable for walking in and a target object is in the area, then marking the moving trajectory data as abnormal. Therefore, the moving trajectory data is determined to be abnormal when the target object enters into an area that is not allowable for walking in that is selected by the user.

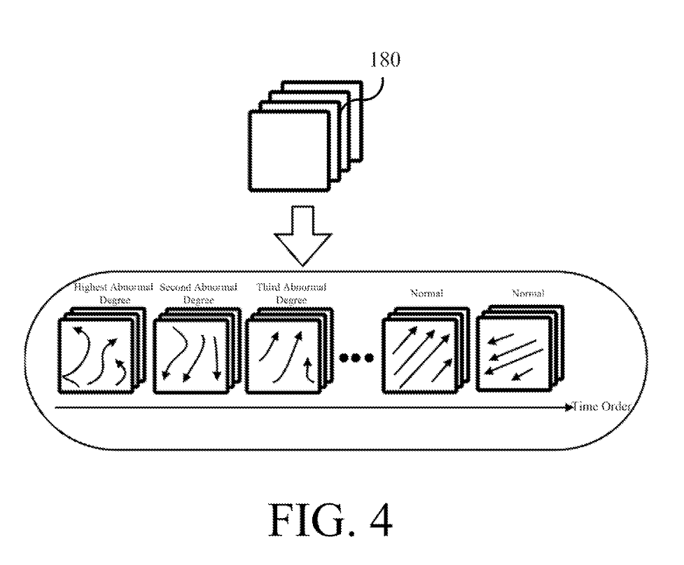

Please refer to FIG. 4. FIG. 4 is a schematic diagram illustrating the video compression of the invention in a specific embodiment. The present invention further comprises the first processing module 18 coupled to the first detection module 14 for generating a first weighting from large to small according to the abnormal degree of the preset cluster. In the present embodiment, the above method of abnormal detection will generate a first weighting for the cluster of the trajectory with larger abnormal degree, the purpose thereof sorts the abnormal cluster to the front of the videos appearance time. The horizontal axis is time order, while the original video 180 conducts the video compression, the cluster with highest abnormal degree is sorted to the front of the appearance time, and as the abnormal degree reduces, it is sorted behind the appearance time. In the present embodiment, the sort order of the cluster is from the highest abnormal degree, to the second abnormal degree, the third abnormal degree, until the normal degree.

The second detection module 15 is then coupled to the capture module 11 for detecting the frequency of the trajectory data passing through a target area in order to generate traffic volume data. The present invention sorts in units of clusters and thus determines the priority appearance sorting of the target object in the cluster, which is based on the first weighting generated by the first processing module 18. Therefore, the trajectory of each cluster has an order of appearance belonging to the cluster. In order to avoid the collision between the target objects the first processing module 18 can count for all the trajectory data to get target areas frequently passed through by the target objects, and display the traffic volume data of the target object from low to high by the output device. In the present embodiment, the display of the traffic volume data from low to high is based on different colors, such as from blue to red, but is not limited thereto. The present invention further comprises the second processing module 19 being coupled to the second detection module 15 for generating a second weighting from smallest to largest according to the traffic volume data of the trajectory data. In the present embodiment, the higher second weighting is generated if all of a trajectory passes through the low traffic volume; otherwise, the lower second weighting is generated.

Then, the second detection module 15 is further used for detecting the traffic volume data in order to generate a spatial occupation frequency of the target object in the target area, where the second weighting of the low spatial occupation frequency is larger than the second weighting of the high spatial occupation frequency. In order to improve the compression rate of the video and image, the system will count the spatial occupation frequency of a time zone to reduce the appearance weighting of the object soon passing through the high spatial occupation frequency and increase the appearance weighting of the object soon passing through the low spatial occupation frequency. This can reduce the traffic jam in the video caused by the delay incurred by the collection while the target objects appear in the screen, and prevents the probability of collision between the target objects.

The sequencing module 16 is then coupled to the first detection module 14, the second detection module 15, and the first analysis module 12 for calculating an appearance time of the target object of the preset cluster to be sorted in the video according to the abnormal degree, the traffic volume data, and the trajectory feature. According to the above, the sorted result decides which cluster should be first chosen, wherein the present invention can also utilize the sequencing module 16 that sorts the target object in the video according to the moving speed of the target object from fastest to slowest and the traffic volume data of the target object from smallest to largest. In the present embodiment, all of the target objects in the preset cluster will be re-sorted according to the moving speed and the second weighting, and thus preferentially selecting the target object with the fastest speed and smallest traffic volume. However, the reason to select the target object with the fastest speed is because the target object with the fastest moving speed will collide with the object with slowest moving speed, otherwise the collision will not happen. Therefore, the present invention can initially avoid the mutual collision between the objects resulting in a shielding situation. When the moving objects in the preset cluster finish the selecting, the next cluster is then selected.

Finally, the compression module 17 is coupled to the sequencing module 16 for synthesizing the background data and the target object to be a compressed video according to the appearance time. The present invention comprises a method for synthesizing a new compressed video, wherein the video is first captured by the background data without any moving objects by the capture module, and then synthesizes the background data and the target object selected one by one to a video according to the appearance time of the target object. The compression module 17 then synthesizes the plurality of frames of the target object in the video to form the compressed video one by one. The main goal is to make the target object in the compressed video maintain the same moving action in the original video. Then, the frames of the target object in the original video are synthesized to form a new compressed video one by one.

Therefore, the system for compressing the video of the present invention can compress the hours of surveillance video into a few minutes of video without missing any moving procedure of the target object. The present invention can place the target object from a different time section into the same time section and maintain the movement of the target object, thus reaching a compressed effect.

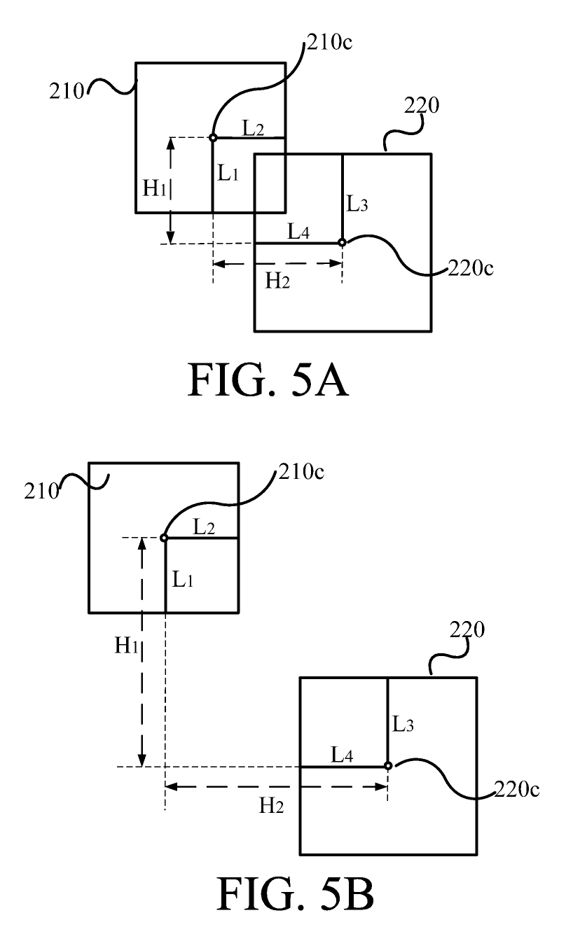

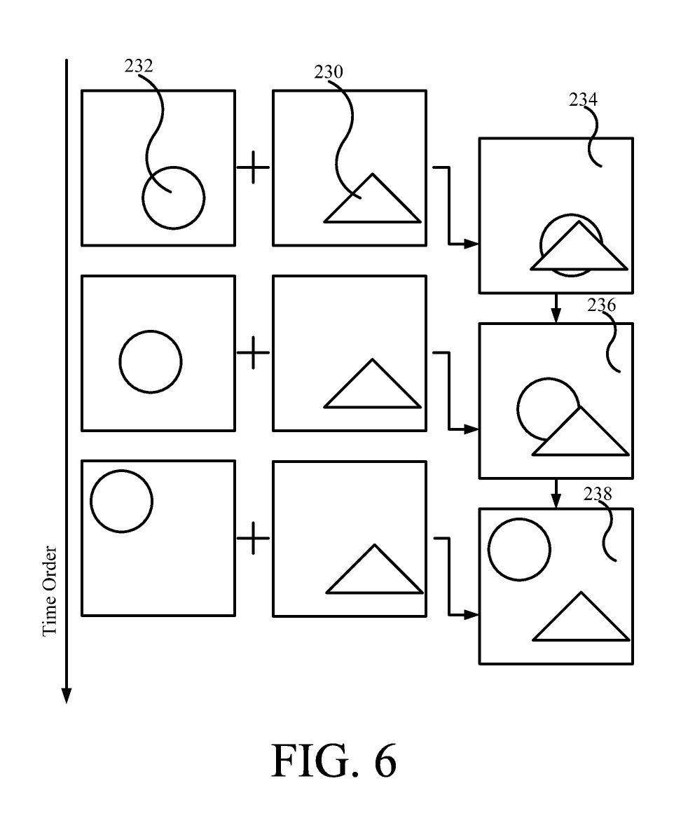

Additionally, the present invention further comprises a third analysis module 21, a third detection module 22, and a third processing module 23, to guarantee that the target objects will not collide with each other. While synthesizing each frame, the present invention will predict whether each target objects is moving to a “next movement” and will overlap with the front of the target object in the frame, thereby reaching the purpose of completely preventing two target objects from colliding with each other. Thus, the invention needs to acquire the position, length, and width of the next movement of the target object while processing a target object, and then conducts collision detection with the other moving objects on the screen, as shown in FIG. 5A, FIG. 5B, and FIG. 6. FIG. 5A is a schematic diagram illustrating the collision detection of the invention in a collision specific embodiment. FIG. 5B is a schematic diagram illustrating the collision detection of the invention in a non-collision specific embodiment. FIG. 6 is a schematic diagram illustrating the collision detection of the invention in a specific embodiment. Please refer to FIG. 5A, FIG. 5B. In the present embodiment, the two targets are a first target object 210 and a second target object 220 respectively while conducting the collision detection in the system for compressing the video. First, a third analysis module 21 is coupled to the compression module 17 for analyzing the video and approximating the first target object 210 and the second target object 220 to be a quadrilateral shape in order to analyze half of the sum of the length L1, L3 and width of the quadrilateral shape L2, L4 and a coordinate of a center point 210c, 220c. Then, a third detection module 22 is coupled to the third analysis module 21 for detecting whether a vertical H1 or a horizontal H2 distance of the coordinates 210c, 220c of the center point between the first target object 210 and the second target object 220 are smaller than half of the sum of the length L1, L2 or the width L3, L4 of the first target object 210 and the second target object 220. If it is, then determining the two target objects are in a collision state, as shown in FIG. 5A. If it is not, then determining the two target objects are in a non-collision state, as shown in FIG. 5B. Then, please refer to FIG. 6. In the present embodiment, while conducting the collision detection in the system for compressing the video, the two targets are a third target object 230 and a fourth target object 232 respectively. A third processing module 23 is coupled to the third detection module 22 for “pausing” the movement of the third target object 230, which means to continually synthesize the background data and the frame belonging to the third target object 230 in order to make the third target object 230 be shown on the screen as a stationary frame 236, while the third target object 230 and the fourth target object 232 in the video are the frame 234 with the collision state in the next appearance time, which means that for the third target object 230 will collide the fourth target object 232 in the next step. When synthesizing a frame, the third target object 230 deemed as moving to the “next movement” will not collide with the fourth target object 232, and will acquire a frame 238 having the non-collision state, and then finishing the action of the pause and continually synthesizing the background data and the other remaining frames of the target object (not shown in the figure).

The system for compressing a video 1 comprises a capture module 11, a first analysis module 12, a clustering module 13, a first detection module 14, a second detection module 15, a sequencing module 16, a compression module 17, a first processing module 18, a second processing module 19, a third analysis module 21, a third detection module 22, and a third processing module 23.

Finally, the capture module 11, the first analysis module 12, the clustering module 13, the first detection module 14, the second detection module 15, the sequencing module 16, the compression module 17, the first processing module 18, the second processing module 19, the third analysis module 21, the third detection module 22, and the third processing module 23 are comprised by the system for compressing a video 1, and the above mentioned kinds of modules are stored in a memory, but is not limited to the above modules. In practical applications, other executable modules can also be stored in a memory. In the present invention, the memory can be an access memory, a hard disk, a read-only memory, or a CD, but is not be limited thereto. Meanwhile, in the present embodiment, the system for compressing the video 1 can be performed by a computer, such as a desktop computer or a notebook computer, but is not limited thereto. In practical applications, the system for compressing the video 1 may also be a server, a cell phone, a personal digital assistant, a smart phone, etc. The source of the video of the system for compressing the video 1 can be acquired by a monitor, but is not limited thereto. In practical application, it may also be a camcorder, a CD, or a network.

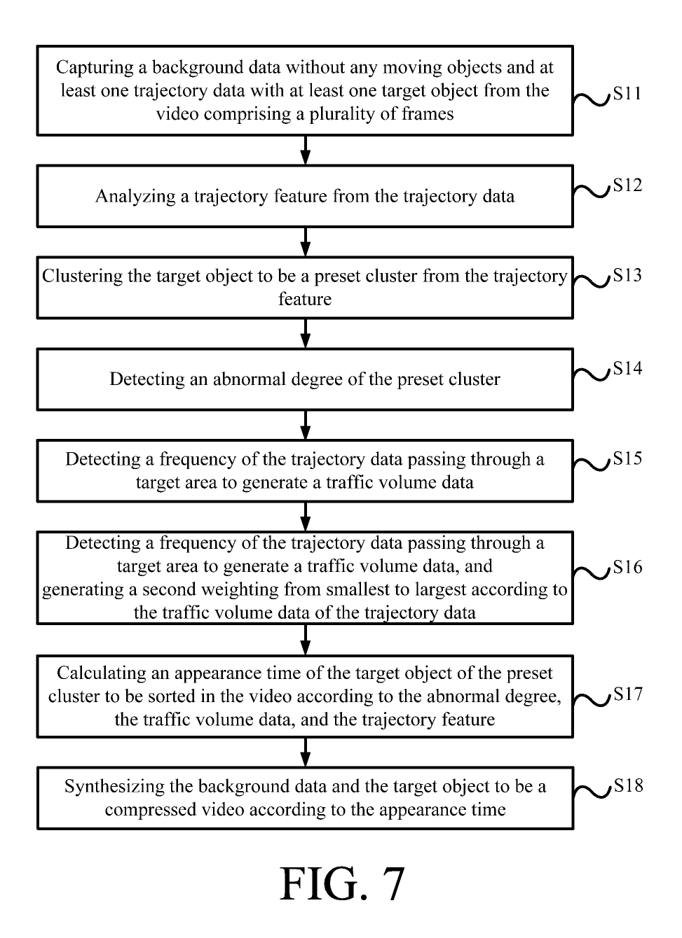

Moreover, the present invention further provides a method for compressing the video, as shown in FIG. 7. FIG. 7 is a flow chart illustrating a method for compressing the video of the present invention in a specific embodiment. The method processes is as follows: (S11) capturing background data without any moving objects and at least one trajectory data with at least one target object from the video comprising a plurality of frames; (S12) analyzing a trajectory feature from the trajectory data; (S13) clustering the target object to be a preset cluster from the trajectory feature; (S14) detecting an abnormal degree of the preset cluster; (S15) detecting a frequency of the trajectory data passing through a target area to generate a traffic rate data; (S16) detecting a frequency of the trajectory data passing through a target area to generate a traffic volume data, and generating a second weighting from smallest to largest according to the traffic volume data of the trajectory data; (S17) calculating an appearance time of the target object of the preset cluster to be sorted in the video according to the abnormal degree, the traffic rate data, and the trajectory feature; and (S18) synthesizing the background data and the target object to be a compressed video according to the appearance time. The method for compressing the video provided by the present invention further comprises: analyzing the video and approximating the target object to be a quadrilateral shape to analyze half of the sum of the length and the width of the quadrilateral shape and a coordinate of a center point; detecting whether a distance of the coordinate of the center point between two target objects is smaller than half of the sum of the length and the width of the two target objects. If it is, then determining the two target object are in a collision state, if it is not, then determining the two target object are in a non-collision state; and continually synthesizing the frame belonging to the target object and the background data while the two target objects in the video are in the collision state in the next appearance time until the two target objects in the next frame are in the non-collision state, and then synthesizing the background data and the other remaining frames.

In summary, the present invention provides a method for compressing a video and a system thereof. Compared to conventional technology, the system of the present invention can capture a background portion from a video and reserve characteristics such as the moving route or speed of a target object. Based on non-collision among the objects, the objects existing at different times can be re-synthesized into the same time section to generate a compressed video with the shortest duration while still retaining most of the details from the original video. This reduces the time needed for forensic officers to filter the video, and reaches the goal of having a compressed video with eye viewing comfort. Therefore, the present invention considers the moving direction of the entire trajectory in the screen as harmonious, and whether after synthesis, two or more of the target objects shadow each other. These questions are solved by the present invention's proposed solutions. Meanwhile, the present invention can count the spatial occupation frequency in order to count the moving route of the target object, to find bottleneck points passed through most frequently by the target objects in the monitoring space to process priority, and classifying the clustering and moving speed etc. condition to weight to strengthen the compressed effect of the video.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

1. A system for compressing a video comprising:
a capture module, for capturing a background data without any moving objects and at least one trajectory data with at least one target object from the video comprising a plurality of frames;
a first analysis module, coupled to the capture module for analyzing a trajectory feature from the trajectory data;
a clustering module, coupled to the first analysis module for clustering the target object to be a preset cluster from the trajectory feature; and
a compression module, coupled to the clustering module, the capture module, and the first analysis module for synthesizing the background data and the target object to be a compressed video according to the preset cluster, the trajectory data, and the trajectory feature.

2. The system for compressing the video of claim 1, further comprising:
a first detection module, coupled to the clustering module for detecting an abnormal degree of the preset cluster;
a second detection module, coupled to the capture module for detecting the frequency of the trajectory data passing through a target area to generate a traffic volume data; and
a sequencing module, coupled to the first detection module, the second detection module, and the first analysis module for calculating an appearance time of the target object of the preset cluster to be sorted in the video according to the abnormal degree, the traffic volume data, and the trajectory feature;
wherein the compression module is coupled to the sequencing module for synthesizing the background data and the target object to be a compressed video according to the appearance time.

3. The system for compressing the video of claim 1, wherein the trajectory feature is a moving direction and a moving speed of the target object and an X-coordinate and a Y-coordinate of the target object.

4. The system for compressing the video of claim 2, further comprising:
a first processing module, coupled to the first detection module for generating a first weighting from large to small according to the abnormal degree of the preset cluster; and
a second processing module, coupled to the second detection module for generating a second weighting from smallest to largest according to the traffic volume data of the trajectory data.

5. The system for compressing the video of claim 2, wherein the sequencing module sorts the target object in the video according to the moving speed of the target object from fastest to slowest and the traffic volume data of the target object from smallest to largest.

6. The system for compressing the video of claim 5, wherein the second detection module is further used for detecting the traffic volume data in order to generate a spatial occupation frequency of the target object in the target area, and the second weighting of the low spatial occupation frequency is larger than the second weighting of the high spatial occupation frequency.

7. The system for compressing the video of claim 1, wherein the compression module synthesizes the plurality of frames of the target object in the video to form the compressed video one by one.

8. The system for compressing the video of claim 2, further comprising:
a third analysis module, coupled to the compression module for analyzing the video and approximating the target object to be a quadrilateral shape to analyze half of the sum of the length and width of the quadrilateral shape and a coordinate of a center point;
a third detection module, coupled to the third analysis module for detecting whether a distance of the coordinate of the center point between two target objects is smaller than half of the sum of the length and the width of the two target objects, if it is, then determining the two target objects are in a collision state, if it is not, then determining the two target objects are in a non-collision state; and
a third processing module, coupled to the third detection module for continually synthesizing the frame belonging to the target object and the background data while the two target objects in the video are in the collision state in the next appearance time until the two target objects in the next frame are in the non-collision state, and then synthesizing the background data and the other remaining frames.

9. A method for compressing a video comprising:
capturing a background data without any moving objects and at least one trajectory data with at least one target object from the video comprising a plurality of frames;
analyzing a trajectory feature from the trajectory data;
clustering the target object to be a preset cluster from the trajectory feature;
detecting an abnormal degree of the preset cluster;
detecting a frequency of the trajectory data passing through a target area to generate a traffic volume data;
calculating an appearance time of the target object of the preset cluster to be sorted in the video according to the abnormal degree, the traffic volume data, and the trajectory feature; and
synthesizing the background data and the target object to be a compressed video according to the appearance time.

10. The method for compressing the video of claim 9, further comprising:
analyzing the video and approximating the target object to be a quadrilateral shape to analyze half of the sum of the length and the width of the quadrilateral shape and a coordinate of a center point;
detecting whether a distance of the coordinate of the center points between two target objects is smaller than half of the sum of the length and the width of the two target objects, if it is, then determining the two target object are in a collision state, if it is not, then determining the two target object are in a non-collision state; and
continually synthesizing the frame belonging to the target object and the background data while the two target objects in the video are in the collision state in the next appearance time until the two target objects in the next frame are in the non-collision state, and then synthesizing the background data and the other remaining frames.
